(19) United States
(12) Patent Application Publication
(10) Pub. No.: US 2007/0299919 A1
(43) Pub. Date: Dec. 27, 2007

(54) METHOD OF INITIATING AUTOMATIC ACTIONS BY AN INSTANT MESSENGER SERVICE IN RESPONSE TO IDENTIFIED INCOMING MESSAGES

(75) Inventors: Linda S. Kellogg, Garner, NC (US); Leslie Short, Garner, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/426,790

(22) Filed: Jun. 27, 2006

(51) Int. Cl. G06F 15/16

(52) U.S. Cl. 709/206

(57) ABSTRACT

A method for initiating an automatic action by an instant messenger service (IMS) device in response to an identified incoming message, including: pre- configuring an action list to be executed on a first IMS device when the user of the first IMS device is unavailable, the action list containing specific executable actions for execution; receiving from a second IMS device on the first IMS device the incoming message; identifying on the first IMS device the identity of the sender of the incoming message and the contents of the incoming message; comparing the identity of the sender and the contents of the incoming message to the senders' names and contents identified on the action list for a match; and executing the specific action associated with an identified sender's name and contents on the action list when a match occurs.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to communications and information management, and more particularly, to a method for initiating an automatic action by an instant messenger service (IMS) in response to an identified incoming message.

2. Description of Background

Instant messaging (IM) is relatively easy to utilize and it is very useful, as such, IM is becoming more and more ubiquitous. IM is widespread throughout the public domain and is becoming one of the primary communication methods for many businesses.

With the widespread acceptance and reliance on IM, a sender of a message generally has an expectation of being able to contact another person relatively quickly, such as a customer service representative, etc. When the desired contact person is not available, the sender generally feels apprehensive and frustrated that the other person did not respond. More importantly, the sender still has unresolved issues because the sender was not able to address their concerns to the other person. For example, a user may be logged onto their IM system, but the user may have stepped out of the office, gone for a coffee, be attending a meeting or for any other number of reasons, may not be at their personal computer when a message arrives. For businesses, this frustration may actually result in a loss of productivity, customer dissatisfaction and/or missed business opportunities.

For example, a customer support person is involved in a serious customer situation and is using IM to work with the customer account team. The customer support person gets called away to help on another problem and misses an urgent IM asking them to provide a known solution for a hot problem. If the customer support person had known about the message, the customer support person could have quickly provided the requested help. The account team continues to send messages but does not receive any response. In the end, the account team attempts to call the customer support person but is still unable to reach the customer support person because the support person is away from their desk. Eventually, the account team contacts someone who is able to locate the support person, but by now the account customer has lost valuable business due to the systems being down and the account team is quite frustrated.

Thus, there is a need of a method for initiating an automatic action by an instant messenger service (IMS) device in response to an identified incoming message, such method should allow for different actions depending on the identity of the incoming message and its content.

### SUMMARY OF THE INVENTION

The shortcomings of the prior art are overcome and additional advantages are provided through the provision of a method for initiating an automatic action by an instant messenger service (IMS) device in response to an identified incoming message, comprising: pre-configuring an action list to be executed on a first IMS device when the user of the first IMS device is unavailable, the action list containing specific executable actions for execution when at least one of the following occurs, (i) a specific person has been identified as the sender of an incoming message, and (ii) the incoming message contains specific content; receiving from a second IMS device on the first IMS device the incoming message; identifying on the first IMS device the identity of the sender of the incoming message and the contents of the incoming message; comparing the identity of the sender and the contents of the incoming message to the senders' names and contents identified on the action list for a match; and executing the specific action associated with an identified sender's name and contents on the action list when a match occurs.

The shortcomings of the prior art are overcome and additional advantages are provided through the provision of a system for initiating an automatic action by an instant messenger service (IMS) device in response to an identified incoming message, comprising: a first IMS device; and a second IMS device communicatively coupled to the first IMS device, the system including software to implement a method comprising: pre-configuring an action list to be executed on a first IMS device when the user for the first IMS device is unavailable, the action list containing specific executable actions for execution when at least one of the following occurs, (i) a specific person has been identified as the sender of an incoming message, and (ii) the incoming message contains specific content; receiving from a second IMS device on the first IMS device the incoming message; identifying on the first IMS device the identity of the sender of the incoming message and the contents of the incoming message; comparing the identity of the sender and the contents of the incoming message to the senders' names and contents identified on the action list for a match; and executing the specific action associated with an identified sender's name and contents on the action list when a match occurs.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a method for initiating an automatic action by an instant messenger service (IMS) device in response to an identified incoming message.

### BRIEF DESCRIPTION OF THE DRAWING

The subject matter, which is regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for initiating an automatic action by an instant messenger service device; and

FIG. 2 is an alternative embodiment of the invention shown in FIG. 1.

The detailed description explains the preferred embodiments of the invention, together with advantages and features, by way of example with reference to the drawing.

### DETAILED DESCRIPTION OF THE INVENTION

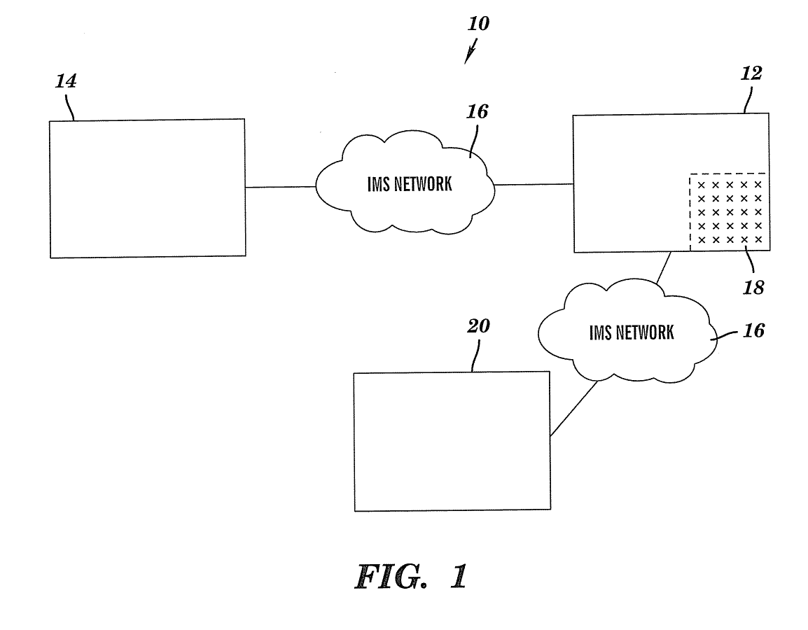

Referring to FIG. 1, a system 10 for initiating an automatic action by an instant messenger service (IMS) device in response to an identified incoming message, is shown. The system 10 includes a first IMS device 12 having an action list 18 and a second IMS device 14. The second IMS device 14 is communicatively coupled to the first IMS device 12. As shown, the first IMS device 12 is coupled to the second IMS device 14 via an IMS network 16 such that the first IMS device 12 and the second IMS device 14 are communicatively coupled together. It should be known that another bus form connection would suffice for communicatively coupling the first IMS device 12 and the second IMS device 14 together. The system 10 includes software to implement a method for initiating an automatic action by an instant messenger service (IMS) device in response to an identified incoming message.

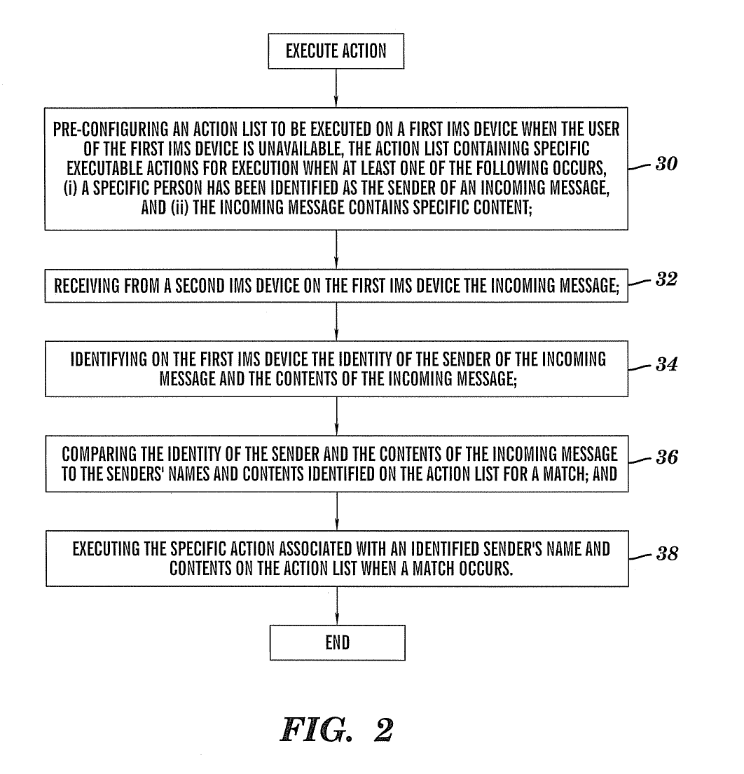

Referring to FIG. 2, at the start of the method, at step 30, the action list 18 is pre-configured by the user of the first IMS device 12. The user pre-configures the action list 18 by putting a series of instructions on the action list 18 that are to be initiated and executed when the user is unavailable. The action list 18 shall be executed on the first IMS device 12. The action list 18 contains specific executable actions for execution when one of the following events occurs, (i) a specific person has been identified as the sender of an incoming message, and (ii) the incoming message contains specific content.

Then at step 32, the first IMS device 12 receives the incoming message from the second IMS device 14. Another person utilizing the second IMS device 14 drafts a message and sends the message from the second IMS device 14 to the first IMS device 12 via the IMS network 16 coupling. The message can contain various forms of information but one thing that shall definitely be included with the message is the sender's name, this allows the user at the first IMS device 12 to be able to identify the sender of the message.

Then at step 34, the identity of the sender of the incoming message and the contents of the incoming message are ascertained. This identification process occurs on the first IMS device 12.

Then at step 36, the process of comparing the identity of the sender of the incoming message and the contents of the incoming message to the senders' names and contents identified on the action list 18 for a match, occurs.

Then at step 38, the specific action associated with an identified sender's name and/or associated with an identified content on the action list 18 is executed.

For example, the customer support person configures the first IMS device 12 to recognize incoming messages from the customer account team. If the customer support person is at their desk and responding to messages, then the first IMS device 12 takes no additional action. If however the customer support person moves away from their desk, then the first IMS device 12 may take action.

There are various actions that can be executed when a match occurs. Such as, the identified sender may be provided with a mobile phone contact number where the user of the first IMS device 12 can be reached.

For example, the customer support person clicks on the first IMS device 12 away function to let users know that they are away from their computer. For the customer account team, the first IMS device 12 has been configured to take specific action if a message is received and the user is away. The action to be taken was also configured by the customer support person and in this case, the action is notify the account representative that they are away and to provide the account representative with a mobile phone number where the customer support person can be reached if urgently required.

Alternatively, when a match occurs, a pager in the possession of the user of the first IMS device 12 may be activated. The pager notifies the first IMS device 12 user that the sender of the incoming message is attempting to contact the first IMS device 12 user.

Alternatively, when a match occurs, the phone number of the user of the second IMS device 14 may be called and a pre-recorded message activated for the second IMS device 14 user. The recorded message states that the first IMS device 12 user is unavailable, furthermore, the identity of the incoming message received by the user of the first IMS device 12 shall be imbedded in the recorded message and played with the message.

Alternatively, when a match occurs, the identified message can be re-routed to another user of a third IMS device 20 for immediate response. The first IMS device 12 is configured to notify the identified sender of the previous incoming message that the message has be re-routed. The IMS network 16 communicatively couples the third IMS device 20 and the first IMS device 12 together.

When no match occurs, an unavailable message is sent from the first IMS device 12 to the second IMS device 14.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for initiating an automatic action by an instant messenger service (IMS) device in response to an identified incoming message, comprising:
pre-configuring an action list to be executed on a first IMS device when the user of the first IMS device is unavailable, the action list containing specific executable actions for execution when at least one of the following occurs, (i) a specific person has been identified as the sender of an incoming message, and (ii) the incoming message contains specific content;
receiving from a second IMS device on the first IMS device the incoming message;
identifying on the first IMS device the identity of the sender of the incoming message and the contents of the incoming message;
comparing the identity of the sender and the contents of the incoming message to the senders' names and contents identified on the action list for a match; and
executing the specific action associated with an identified sender's name and contents on the action list when a match occurs.

2. The method of claim 1, wherein the specific action to be executed when a match occurs includes:
providing the identified sender with a mobile phone contact number where the user of the first IMS device can be reached.

3. The method of claim 1, wherein the specific action to be executed when a match occurs includes:
activating a pager in the possession of the user of the first IMS device that notifies the first IMS device user that the sender is attempting to contact the first IMS user.

4. The method of claim 1, wherein the specific action to be executed when a match occurs includes:
calling the phone number of the user of the second IMS device and activating a pre-recorded message for the second IMS device user that the first IMS device user is unavailable, the first IMS device imbedding the identity of the incoming message received by the user of the first IMS device.

5. The method of claim 1, wherein the specific action to be executed when a match occurs includes:
re-routing the identified message to another user of a third IMS device and notifying the identified sender that this re-routing process has occurred.

6. The method of claim 1, further comprising:
sending an unavailable response from the first IMS device to the second IMS device when no match occurs.

7. A system for initiating an automatic action by an instant messenger service (IMS) device in response to an identified incoming message, comprising:
a first IMS device; and
a second IMS device communicatively coupled to the first IMS device, the system including software to implement a method comprising:
pre-configuring an action list to be executed on a first IMS device when the user of the first IMS device is unavailable, the action list containing specific executable actions for execution when at least one of the following occurs, (i) a specific person has been identified as the sender of an incoming message, and (ii) the incoming message contains specific content;
receiving from a second IMS device on the first IMS device the incoming message;
identifying on the first IMS device the identity of the sender of the incoming message and the contents of the incoming message;
comparing the identity of the sender and the contents of the incoming message to the senders' names and contents identified on the action list for a match; and
executing the specific action associated with an identified sender's name and contents on the action list when a match occurs.
